(19) United States
(12) Patent Application Publication
(10) Pub. No.: US 2012/0278083 A1
(43) Pub. Date: Nov. 1, 2012

(54) VOICE CONTROLLED DEVICE AND METHOD

(75) Inventors: YING-CHUAN YU, Tu-Cheng (TW); HSING-CHU WU, Tu-Cheng (TW)

(73) Assignee: HON HAI PRECISION INDUSTRY CO., LTD., Tu-Cheng (TW)

(21) Appl. No.: 13/214,233

(22) Filed: Aug. 22, 2011

(30) Foreign Application Priority Data
Apr. 27, 2011 (TW) 100114620

(51) Int. Cl. G10L 11/00

(52) U.S. Cl. 704/275; 704/E11.001

(57) ABSTRACT

A voice control device includes a storage module, a voice recording module, and a processing module. The storage module stores a number of computerized voice commands. The voice recording module records audio signals of a user. The processing module processes the recorded voice signals to a machine readable command, determines whether the determined machine readable command matches one stored computerized voice command, and controls the device to execute a function according to the machine readable command if the determined machine readable command matches one stored computerized voice command. The processing module stores the determined machine readable command as a history command. The processing module further obtains all the history commands and determines which function the voice controlled device is to do according to the history commands if the determined machine readable command is partially the same as at least two of the stored computerized voice commands.

### BACKGROUND

1. Technical Field

The present disclosure relates to electronic devices and, particularly, to a voice controlled device and a voice control method.

2. Description of Related Art

Voice controlled devices have been available and in use for many years. Many voice controlled devices will work with only a voice command collected by an audio recording unit, for example, a microphone, matching a stored command. The devices execute a function corresponding to the voice command. If the voice command partially matches the stored command, the devices will abandon this voice command and not execute any function.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a voice controlled device in accordance with an exemplary embodiment.

FIGS. 2A-2B show a flowchart of a voice control method in accordance with an exemplary embodiment.

### DETAILED DESCRIPTION

Embodiments of the present disclosure will now be described in detail, with reference to the accompanying drawings.

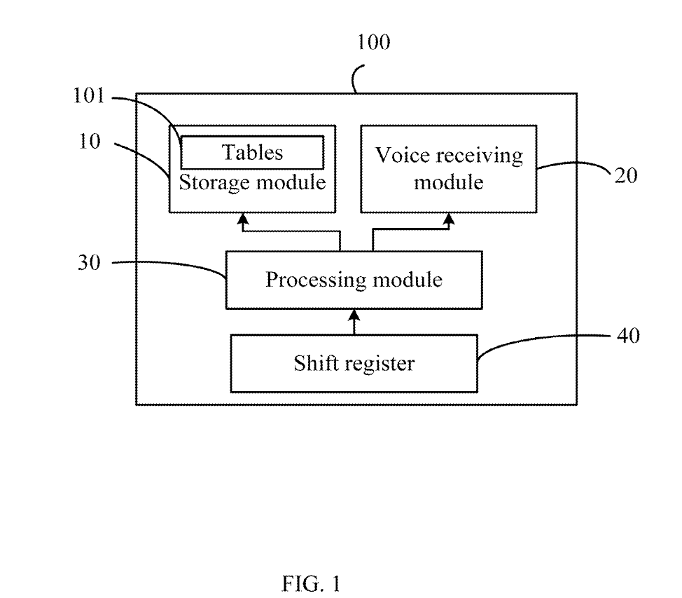

Referring to FIG. 1, a voice controlled device 100 includes a storage module 10 as a first storage module, a voice recording module 20, a processing module 30, and a shift register 40 as a second storage module.

The storage module 10 stores a number of computerized voice commands.

The voice recording module 20 records audio signals of a user. The voice recording module 20 may be a microphone.

The processing module 30 processes the recorded voice signals to determine a machine readable command. The processing module 30 further determines whether the determined machine readable command matches one stored computerized voice commands. If the processing module 30 determines the determined machine readable command matches one stored computerized voice commands, the processing module 30 controls the device 100 to execute a function according to the determined machine readable command, and stores the determined machine readable command to the shift register 40 as a history command. In this embodiment, the shift register 40 stores a number of history commands.

When the processing module 30 determines that the determined machine readable command is partially the same as two or more stored computerized voice commands, the processing module 30 obtains all of the history commands from the shift register 40, and determines which function the device 100 is to do according to the history commands. For example, in this embodiment, if all of the stored history commands in the shift register 40 are the same, the processing module 30 controls the device 100 to execute a function corresponding to any of the history commands. If at least two latest history commands are the same but not all of the stored history commands are the same, the processing module 30 controls the device 100 to execute a function corresponding to the same latest history commands. The processing module 30 further stores the command that the processing module 30 has determined to execute a function corresponding to in the shift register 40 as one history command. When the processing module 30 determines that the determined machine readable command matches none stored computerized voice commands, the processing module 30 abandons the machine readable command and does not execute any function. For better understanding the present disclosure, an example is given to illustrate the present disclosure. In this example, the device 100 is a projector. The stored computerized voice commands include a “page up” command, a “page down” command, a “start” command, and a “finish” command, for example. If the determined machine readable command is the “page down” command, the processing module 30 plays a next page of a document and stores the determined machine readable command “page down” to the shift register 40. If the determined machine readable command is a “page” command, the processing module 30 determines which function the projector is to do according to the stored history commands. If the processing module 30 determines the history commands from the shift register 40 are the “page down” command or at least two history commands recently stored are the “page down” command, the processing module 30 determines that a user wants to view a next page of a running document, and plays the next page.

In an alternative embodiment, the storage module 10 may store a number of tables 101. Each table 101 records a number of computerized voice commands. Each of the computerized voice commands in each of the tables 101 corresponds to a function, and when the processing module 30 determined which function to execute based on the tables 101. For example, the computerized voice commands in one table 101 are used to control operation of a PowerPoint application, and the computerized voice commands in another table 101 are used to control operation of an audio player application. The processing module 30 may provide a user interface for a user to select one table 101 as an aim table. When a table 101 is selected, the processing module 30 only searches in the selected table 101 to determine whether a determined machine readable command matches with one of the computerized voice commands in the selected table 101. That is, only the computerized voice commands in the selected table 101 are used. With such configuration, searching speed of the device 100 increases.

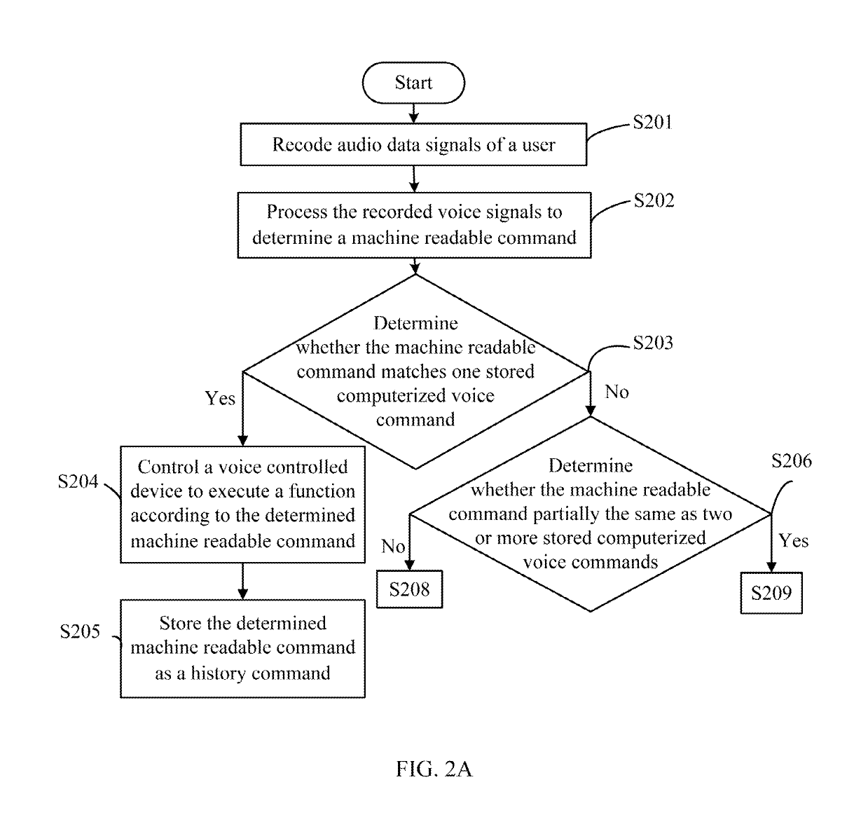

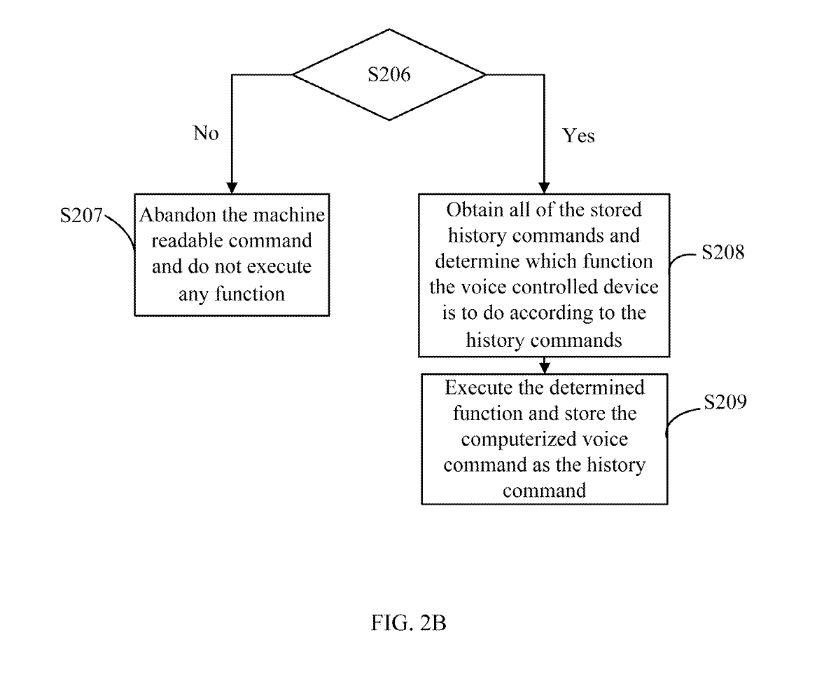

FIGS. 2A-2B show a flowchart of a voice control method in accordance with an exemplary embodiment.

In step S201, the voice recording module 20 records audio signals of a user.

In step S202, the processing module 30 processes the recorded voice signals to determine a machine readable command.

In step S203, the processing module 30 determines whether the determined machine readable command matches one stored computerized voice command. If yes, the procedure goes to step S204, otherwise, the procedure goes up to step S206.

In step S204, the processing module 30 controls the device 100 to execute a function according to the determined machine readable command.

In step S205, the processing module 30 stores the determined machine readable command to the shift register 40 as a history command.

In step S206, the processing module 30 determines whether the machine readable command partially the same as two or more stored computerized voice command. If no, the procedure goes to step S207, otherwise, the step goes up to step S208.

In step S207, the processing module 30 abandons the machine readable command and does not execute any function.

In step S208, the processing module 30 obtains all of the history commands from the shift register 40, and determines which function the device 100 is to do according to the history commands, as described earlier.

In step S209, the processing module 30 controls the device 100 to execute the determined function and stores the command which the processing module 30 determines to execute a function corresponding to in the shift register 40 as one history command.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A voice controlled device comprising:
a first storage module storing a plurality of computerized voice commands;
a second storage module;
a voice recording module to record audio signals of a user; and
a processing module to process the recoded voice signals to determine a machine readable command, determine whether the determined machine readable command matches one of the stored computerized voice commands, control the voice controlled device to execute a function according to the determined machine readable command if the processing module determines that the determined machine readable command matches one of the stored computerized voice commands, and store the determined machine readable command to the second storage module as a history command; the processing module further to obtain all the history commands from the shift register when the determined machine readable command is partially the same as at least two of the latest stored history commands, and determine which function the voice controlled device is to do according to the same history commands.

2. The voice controlled device as described in claim 1, wherein, when the determined machine readable command is partially the same as at least two of the latest stored history commands, the processing module is to determine the function the voice controlled device is to do according to any of the history commands if all the stored history commands in the shift register are the same.

3. The voice controlled device as described in claim 1, wherein when the determined machine readable command is partially the same as at least two of the latest stored history commands, the processing module is to determine the function the voice controlled device is to do according to the latest history command if at least two latest history commands are the same but not all the stored history commands are the same.

4. The voice controlled device as described in claim 1, wherein the processing module is further to store the command that the processing module has determined to execute a function for according to the history commands stored in the second storage module as a history command.

5. The voice controlled device as described in claim 1, wherein the storage module stores a plurality of tables, each of the table records a plurality of computerized voice commands, each of the computerized voice commands in each of the tables corresponds to a function, and when the processing module determined which function to execute based on the tables.

6. The voice controlled device as described in claim 1, wherein the processing module is further to provide a user interface for a user to select a table as an aim table, and only search in the selected table to determine whether the determined machine readable command matches with one of the computerized voice commands in the selected table.

7. The voice controlled device as described in claim 1, wherein the processing module abandons the machine readable command if the machine readable command partially the same as none of the stored computerized voice command.

8. The voice controlled device as described in claim 1, wherein the second storage module is a shift register.

9. A voice control method comprising:
recording audio signals of a user;
processing the recorded voice signals to determine a machine readable command;
determining whether the determined machine readable command matches one stored computerized voice command;
executing a function according to the determined machine readable command if the determined machine readable command matches one stored computerized voice command;
storing the determined machine readable command as a history command;
determining whether the machine readable command partially the same as two or more stored computerized voice command;
obtaining all the stored history commands and determining a function the voice controlled device being to do according to the history commands if the machine readable command partially the same as two or more stored computerized voice command;
storing the command which is determined to execute a function corresponding to as one history command; and
abandoning the machine readable command if the machine readable command partially the same as none of the stored computerized voice command.

10. The voice control method as described in claim 9, wherein the step of determining a function the voice controlled device is to do according to the history commands comprises:
determining the function the voice controlled device being to do according to any of the history commands if all the stored history commands are the same; and
determining the function the voice controlled device being to do according to the latest history command if at least two latest history commands are the same but not all the stored history commands are the same.
